(19) United States
(12) Patent Application Publication
(10) Pub. No.: US 2016/0251879 A1
(43) Pub. Date: Sep. 1, 2016

(54) VEHICLE LOCK HAVING A CLOSING DEVICE AND VEHICLE HAVING SUCH A VEHICLE LOCK

(71) Applicant: D. LA PORTE SÖHNE GMBH, Wuppertal (DE)

(72) Inventor: Peter BEHNKE, Bochum (DE)

(73) Assignee: D. La Porte Sohne GMBH, Wuppertal (DE)

(21) Appl. No.: 14/905,892

(22) PCT Filed: Jul. 18, 2014
(86) PCT No.: PCT/EP2014/065479

§ 371 Date: Apr. 25, 2016

(30) Foreign Application Priority Data
Jul. 18, 2013 (DE) 10 2013 10 117.5

(51) Int. Cl. E05B 81/20; E05B 85/24; E05B 81/06

(52) U.S. Cl. CPC E05B 81/20; E05B 81/06; E05B 85/24

(57) ABSTRACT

The invention relates to a vehicle lock for locking doors or hatches of motor vehicles, in particular doors or hatches of agricultural machines, such as tractors, or construction machines, having a rotary latch assembly having two rotatably supported rotary latches for encompassing and retaining a striker pin in a preliminary latching position or a final latching position; a pawl for locking the two rotary latches in the preliminary latching position or final latching position thereof; and a closing device, to which the rotary latches are connected in such a way that the rotary latches can be rotatably driven in a respective rotary latch closing direction from the preliminary latching position to the final latching position. The invention further relates to a vehicle having such a vehicle door lock.

### CROSS-REFERENCE TO RELATED APPLICATIONS

This application is the U.S. national phase of PCT Application No. PCT/EP2014/065479 filed on Jul. 18, 2014, which claims priority to DE102013012117.5 filed on Jul. 18, 2013, the disclosures of which are incorporated in their entirety by reference herein.

### FIELD OF THE INVENTION

The invention relates to a vehicle lock having a rotary latch assembly for locking and closing doors or hatches of motor vehicles, in particular doors or hatches of agricultural machines, such as tractors or construction machines, as well as a vehicle having such a vehicle lock.

### BACKGROUND

A door lock of this type is known, for example, from DE 196 53 169 A1. This door lock has a rotary latch assembly with a lock case in which two rotary latches are rotatably supported. The rotary latches serve to accommodate a striker pin, and have a preliminary latching position, or safety locking position, in which the lock, or the door, respectively, is not completely closed, as well as a final latching position, in which the lock, or the door, respectively, is completely closed. A pawl is provided for locking the rotary latches in the preliminary latching position or the final latching position. The known door lock has proven to be effective.

Locks are known from the field of passenger cars, having a closing device, by means of which the lock is automatically brought from its safety latching position into its completely closed final position, without the user having to pull the vehicle door further closed. This occurs as a result of driving the striker pin.

### SUMMARY

The object of the present invention is to provide a vehicle lock having a rotary latch assembly for locking and closing doors or hatches of motor vehicles, in particular doors or hatches of agricultural machines, e.g. tractors, or construction machines, having a closing device, wherein the vehicle lock should always be able to be opened manually. Furthermore, the normal locking function of the lock should not be compromised by the closing device. In particular, the locking function of the lock should also not be compromised when the closing device malfunctions.

This object is achieved by a vehicle lock incorporating the principles of the present invention.

### BRIEF DESCRIPTION OF THE DRAWINGS

The invention shall be explained in greater detail below, by way of example, based on the drawings. Therein:

FIG. 1: shows a front view of a vehicle lock according to the invention, in the open position, with the lock case cover removed.

FIG. 2: shows a front view of the vehicle lock according to the invention, in a safety latching position, or a preliminary latching position, with the lock case cover removed.

FIG. 3: shows a perspective front view of the vehicle lock according to the invention, in accordance with FIG. 2.

FIG. 4: shows a perspective rear view of the vehicle lock according to the invention, in accordance with FIG. 2.

FIG. 5: shows a top view of a rotary latch assembly of the vehicle lock according to the invention.

FIG. 6: shows a top view of a rotary latch assembly of the vehicle lock according to the invention, having a closing lever and drive lever of a closing device.

FIG. 7: shows a front view of the vehicle lock according to the invention in a closed position, with the lock case cover removed, and the drive lever actuated.

FIG. 8: shows a front view of the vehicle lock according to the invention, in the closed position, with the lock case cover removed, and with the drive lever not actuated.

FIG. 9: shows an enlarged top view of a control disk in the preliminary latching position.

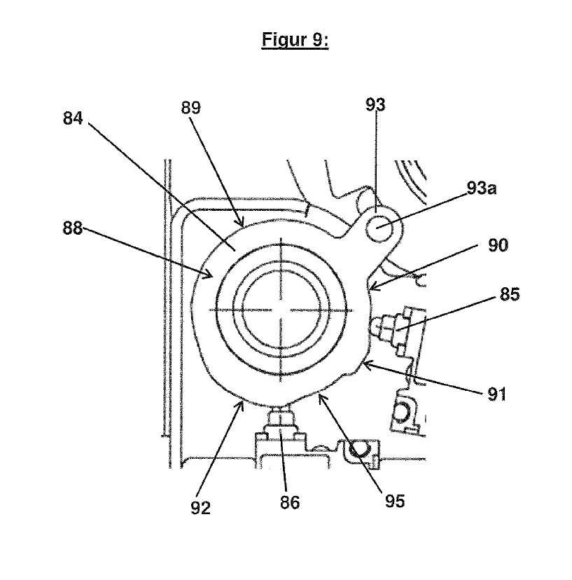

### DETAILED DESCRIPTION

The vehicle lock 1 according to the invention has a rotary latch assembly 2 and a closing device 3.

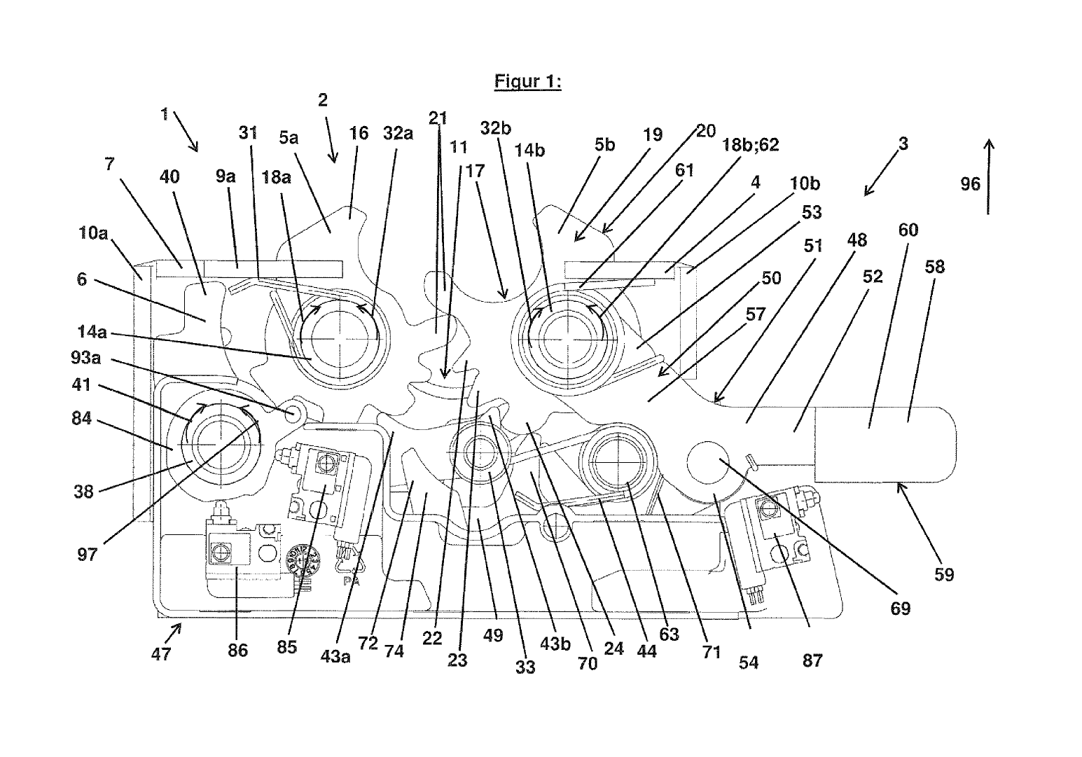

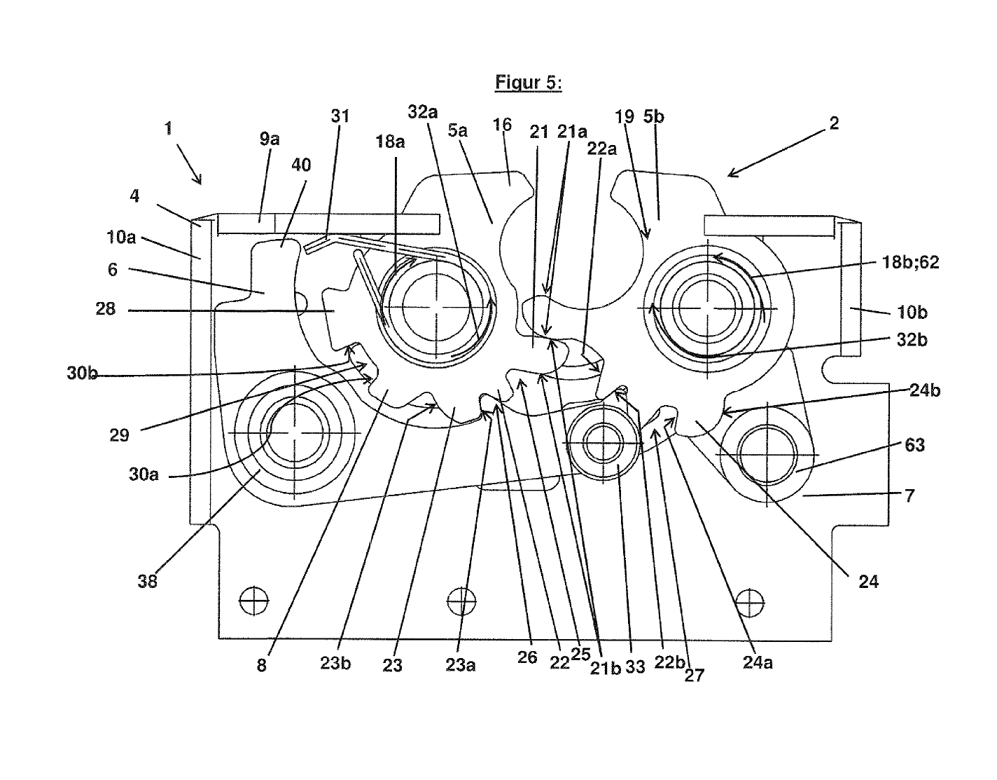

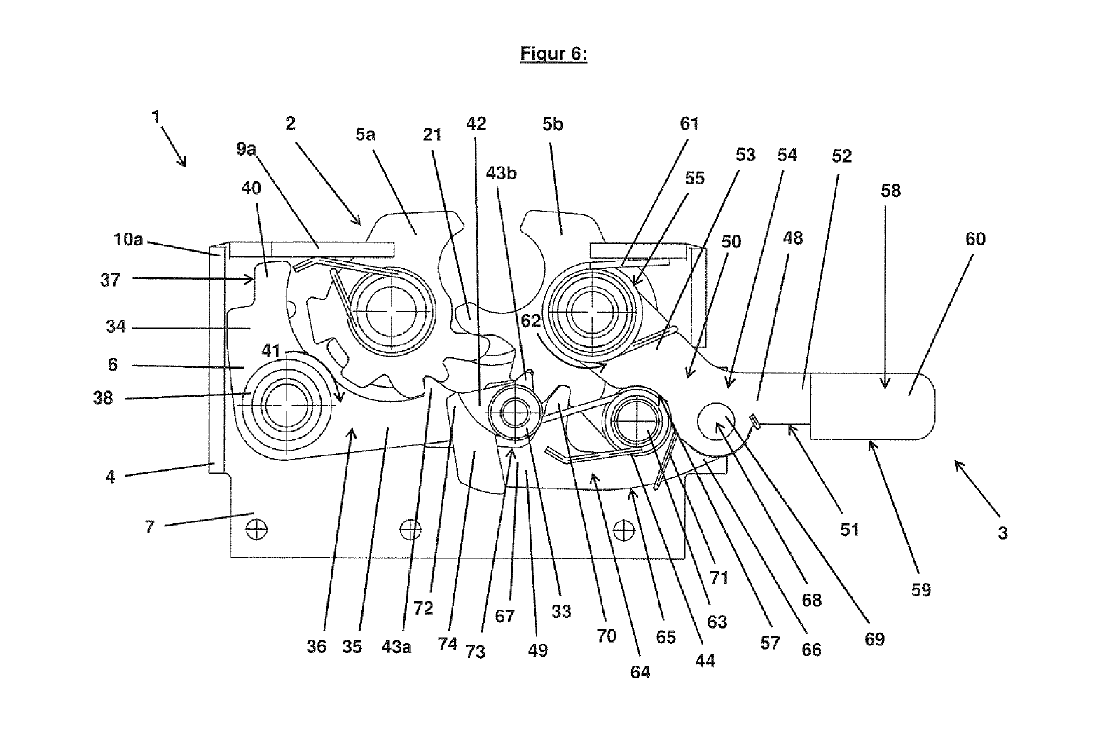

The rotary latch assembly 2 has a lock case 4, two rotary latches 5a;b disposed therein, and a pawl 6. The box-shaped lock case 4 serves as a support for the rotary latches 5a;b and the pawl 6. For this, the lock case 4 has an, in particular planar, base plate, or rear wall 7, and an, in particular plate-shaped, cover or a cover wall (not shown) lying opposite the base plate 7, and parallel thereto, two longitudinal walls 9a;b that are parallel to one another and perpendicular to the base plate 7, as well as two lateral, or side, walls 10a;b that are parallel to one another and perpendicular to the longitudinal walls 9a;b (FIGS. 1-8). A groove-shaped striker pin recess 11, known per se, is formed extending continuously through the base plate 7, the cover and the first longitudinal wall 9a, which creates space for accommodating a striker pin 12, as shall be explained in greater detail below. The striker pin recess 11 is preferably formed such that it is symmetrical to a transverse central plane 13 of the door lock 1, and extends along the transverse central plane 13 and parallel to the cover, seen from the first longitudinal wall 9a, into the base plate 7 and the cover, and opens into a recess bottom 11a, which particularly is round, preferably circular. The striker pin 12 is typically fixedly attached to the vehicle body (not shown). The rotary latch assembly 2 is typically fixedly attached to the vehicle door, or hatch, respectively. This may be reversed, however.

The two rotary latches, or rotary latch components 5a;5b are disposed inside the lock case 4, each of which are rotatably supported on a rotary latch bearing pin 14a;b, such that they can rotate about a rotary latch rotational axis 15a;b. The two rotary latch bearing pins 14a;b are particularly fixedly attached to the base plate 7. The rotary latch rotational axes 15a;b of the two rotary latches 5a;b are spaced apart from one another, and parallel to one another. Furthermore, the rotary latch rotational axes 15a;b are preferably perpendicular to the base plate 7. As a result, the two rotary latches 5a;b are rotatably connected to the base plate 7 such that they can rotate about the respective rotary latch rotational axis 15a;b, and cannot otherwise be rotated or displaced. Furthermore, the two rotary latch rotational axes 15a;b are preferably disposed in the vicinity of the first longitudinal wall 9a, and spaced apart from one another, symmetrically in relation to the transverse central plane 13 of the door lock 1.

The rotary latches 5a;b supported on the rotary latch bearing pins 14a;b are plate-shaped elements, e.g. plates made of steel, which extend parallel to the base plate 7, and are slightly spaced apart therefrom. Each rotary latch 5a;b has a locking lug 16 and a recess 17 in the manner known per se. The recesses 17 adjoin the locking lugs 16, seen in a closing direction 18a;b of the rotary latches. Furthermore, the channels 17 of the two rotary latches 5a;b are disposed such that they face one another, and serve to accommodate the striker pin 12, as shall be explained in greater detail below. In an open lock position, or when the rotary latches 5a;b are in the open position (FIG. 1), in which the door, or hatch, respectively, is open, the latching lugs 16 engage in a slot provided in the first longitudinal wall 9a, extending perpendicular to the transverse central plane 13, and extend laterally beyond the first longitudinal wall 9a.

The rotary latches 5a;b also each have two rotary latch upper surfaces 19, and a rotary latch peripheral wall 20. Furthermore, each of the two rotary latches 5a;b, in particular the rotary latch peripheral walls 20, have an actuation lug 21. The actuation lugs 21 adjoin the recesses 17 in each case, seen in the closing direction 18a;b of the rotary latches. They each have an actuation lug front wall 21a facing toward the recess 17, and an actuation lug rear wall 21b facing away from the recess 17. The actuation lug front wall 21a and the actuation lug rear wall 21b transition into one another. The actuation lugs 21 of the two rotary latches 5a;b abut one another thereby. In particular, the actuation lug front wall 21a of the actuation lug 21 of the first rotary latch 5a abuts the actuation lug rear wall 21b of the actuation lug 21 of the second rotary latch 5a. The actuation lugs 21 of the two rotary latches 5a;b engage with one another, or are interlocked with one another. The two rotary latches 5a;b are disposed on the same plane thereby, meaning that their rotary latch upper surfaces 19 are coplanar to one another in pairs. The rotary latches 5a;b thus do not overlap, seen in a direction parallel to the rotary latch rotational axes 15a;b. The rotary latches 5a;b preferably also do not have an identical spatial shape. They are thus preferably not symmetrical in relation to the transverse central plane 13.

Furthermore, the two rotary latches 5a;b, in particular the rotary latch peripheral walls 20, each have two rotary latch latching lugs 22;23, adjacent to one another in the direction of the circumference. The rotary latch latching lugs 22;23 each adjoin the actuation lugs 21, seen in the closing direction 18a;b of the rotary latches. The rotary latch latching lugs 22;23 are disposed behind one another seen in the closing direction 18a;b of the rotary latches. A first rotary latch latching lug 22 of the rotary latch latching lugs 22;23 adjoins the respective actuation lug 21. The second rotary latch latching lug 23 is disposed downstream of the first rotary latch latching lug 22. The second rotary latch 5b also has a third rotary latch latching lug 24, which is disposed downstream of the second rotary latch latching lug 23. The rotary latch latching lugs 22;23;24 each have a front latching lug flank 22a;23a;24a and a rear latching lug flank 22b;23b;24b.

A first latching recess 25 is formed in each case between the actuation lug 21 and the first rotary latch latching lug 22. A second latching recess 26 is formed in each case between the first and second actuation lugs 22;23. And a third latching recess 27 is formed in each case between the second and third actuation lugs 23;24 of the second rotary latch 5b. The first rotary latch 5a also likewise has a first stop lug 8, disposed downstream of the second rotary latch latching lug 23. A recess between the first stop lug 8 and the second actuation lug 23 does not, however, serve as a latching recess.

The first rotary latch 5a also has a second stop lug 28 adjoining the first stop lug 8 in the closing direction 18a;b of the rotary latches. A drive recess 29 is formed between the second and the first stop lugs 8;28, having a first and second stop edge 30a;b seen in the closing direction 18a;b of the rotary latch.

Furthermore, the rotary latch assembly 2 has a rotary latch spring 31. The rotary latch spring 31 is connected to the first rotary latch 5a, and drives this rotary latch in the direction opposite to the closing direction 18a of the rotary latch, in an opening direction 32a of the rotary latch. The first rotary latch 5a is thus rotatably connected to the rotary latch spring 31 such that the rotary latch can be driven about the rotary latch rotational axis 15a in an opening direction 32a of the rotary latch. The rotary latch spring 31 is braced thereby at one end against the first rotary latch 5a, and against the lock case 4, in particular the first longitudinal wall 9a thereof, at the other end. Because the two actuation lugs 21 of the two rotary latches 5a;b engage with one another, the first rotary latch 5a drives the second rotary latch 5b in its opening direction 32b of the rotary latch. The opening directions 32a;b of the two rotary latches 5a;b oppose one another thereby. The same applies for the closing directions 18a;b of the rotary latches. The second rotary latch 5b is thus connected, in particular via the first rotary latch 5a, to the rotary latch spring 31 such that it can be driven about the rotary latch rotational axis 15b in the opening direction 32a of the rotary latch. There is preferably no separate rotary latch spring for the second rotary latch 5b. But there may be one. The rotary latch spring 31 strives to retain the rotary latches 5a;b in the open position, thus to push the locking lugs 16 facing one another apart.

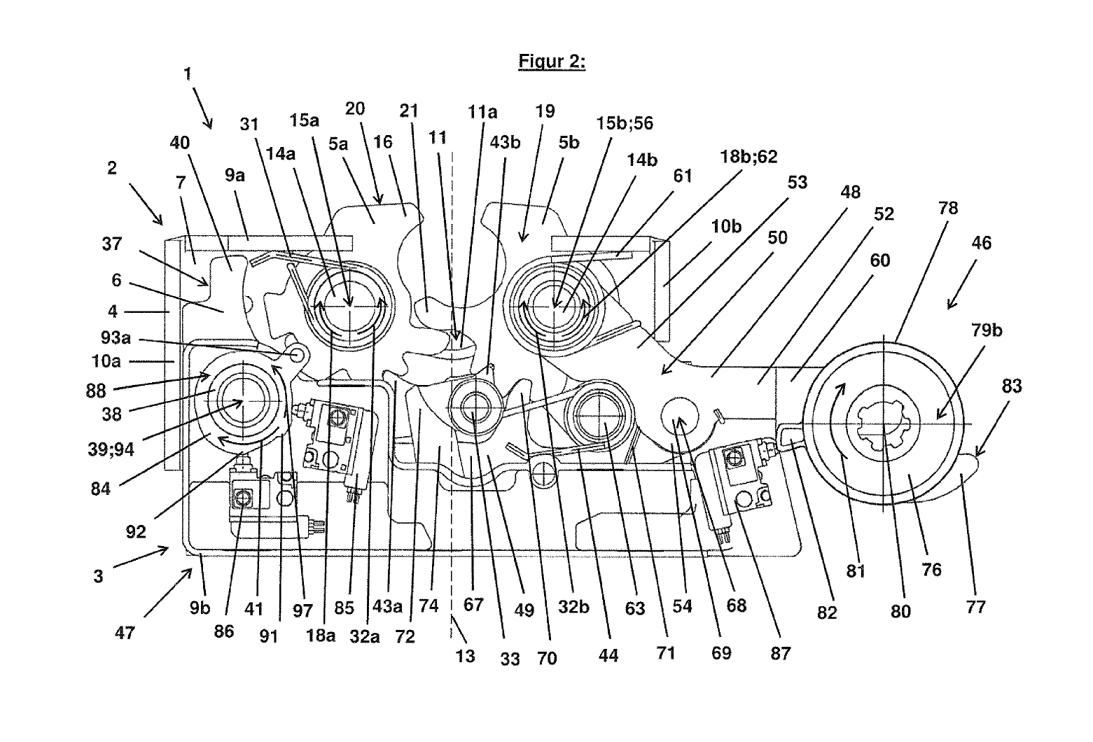

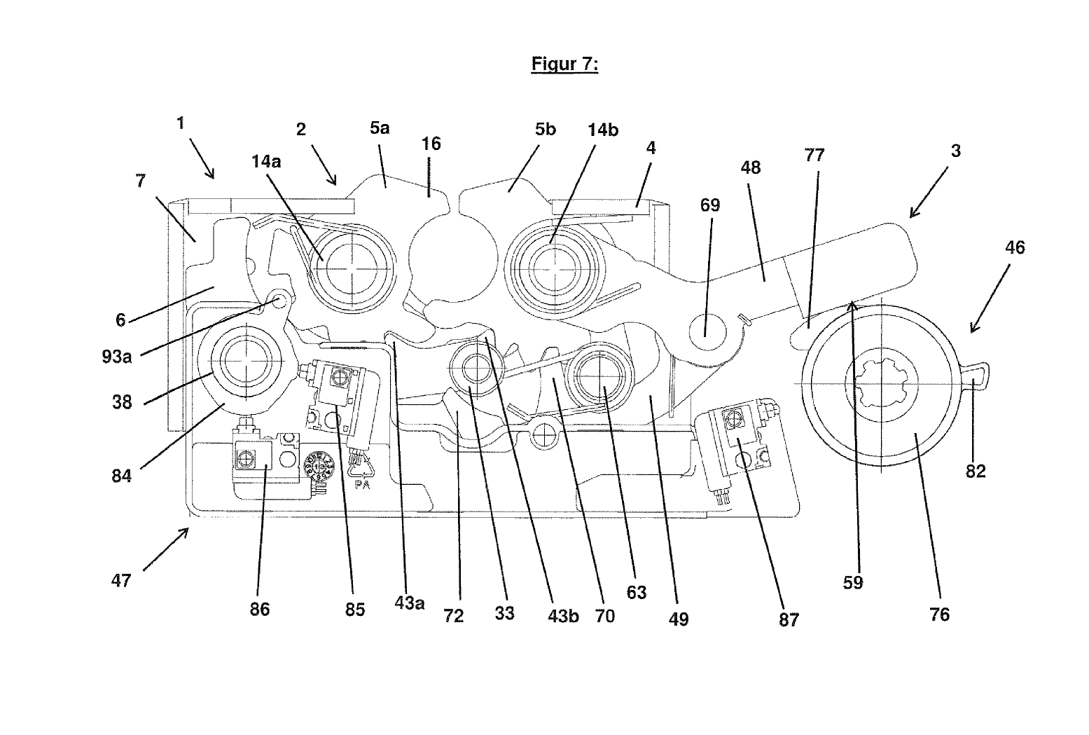

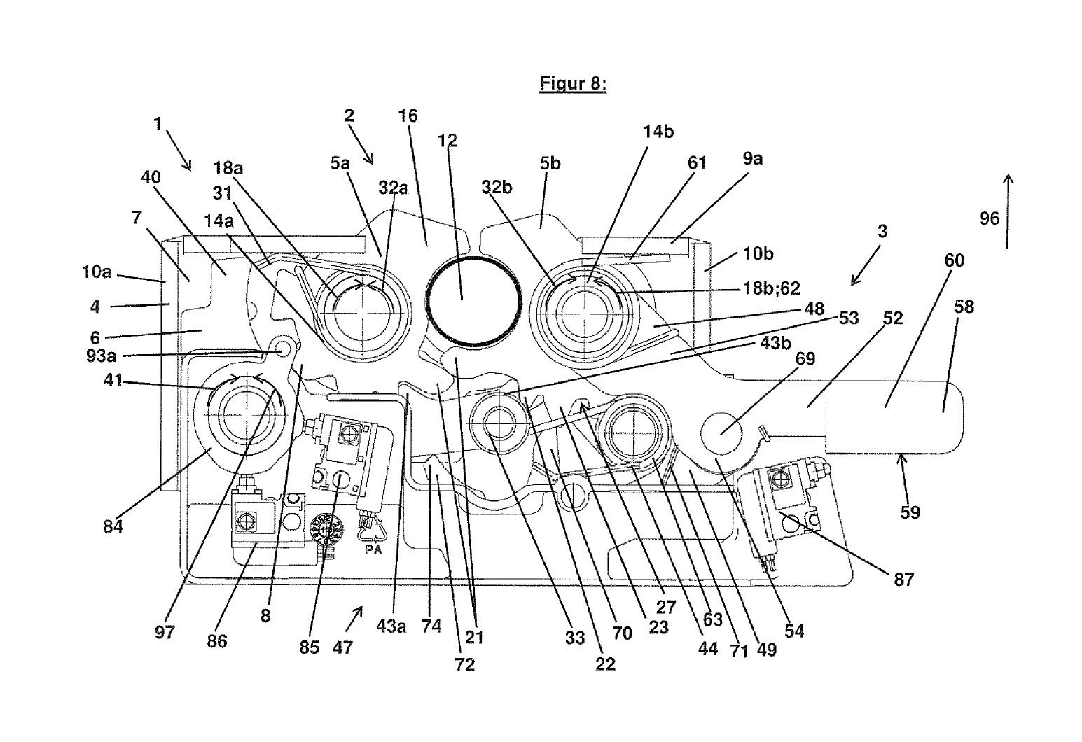

In order to lock the two rotary latches 5a;b, the door lock 1 according to the invention has the pawl 6 that retains the rotary latches 5a;b in their final latching positions (FIGS. 7 and 8) or a preliminary latching position (FIGS. 2-6), or releases the two rotary latches 5a;b. The pawl 6 has pawl arms 34;35 connected to one another at one of their respective ends. The two pawl arms 34;35 are bent down in relation to one another, in particular, substantially perpendicular to one another. Furthermore, the, preferably plate-shaped, pawl 6 has two, in particular planar, pawl surfaces 36 and one pawl peripheral wall 37. The pawl 6 preferably likewise extends parallel to the base plate 7. Furthermore, the pawl 6 is rotatably supported on a pawl bearing pin 38, preferably designed as a hollow cylinder, such that it can rotate about a pawl rotational axis 39. The pawl bearing pin 38 particularly is fixedly connected to the base plate 7. The pawl 6 is thus connected to the base plate 7 such that it can rotate about the pawl rotational axis 39, and otherwise cannot be rotated or displaced. The pawl rotational axis 39 is spaced apart from the two rotary latch rotational axes 15a;b and preferably parallel thereto. In particular, the pawl bearing pin 38 is disposed in a corner region between the second longitudinal wall 9b and the first lateral wall 10a, adjacent to the first rotary latch 5a. Furthermore, the pawl rotational axis 39 is disposed in the connecting region of the first and second pawl arms 34;35.

The first pawl arm 34 has an actuation lug 40 on its free end facing away from the second pawl arm 35, which serves to actuate the pawl 6 with an actuation lever (not shown), which engages in the lock case 4. The pawl 6 can be driven about the pawl rotational axis 39 in a pawl releasing direction 41 by means of the actuation lever. The actuation lever can be pivoted about an axis for this, for example, which axis is perpendicular to the pawl rotational axis 39, and extends parallel to the lateral walls 10a;b. The second pawl arm 35 has a latching piece 42 on its free end, facing away from the first pawl arm 34. The latching piece 42 has two pawl latching lugs 43a;b facing toward the rotary latches 5a;b. One pawl latching lug 43a;b interacts thereby with one rotary latch 5a;b respectively, locking it, as shall be explained in greater detail below. In particular, at first the first pawl latching lug 43a lies against the rear latching lug flank 23b of the second latching lug 23 of the first rotary latch 5a when the door lock 1 and the rotary latches 5a;b are in the open position. The second pawl latching lug 43b is disposed in the third latching recess 27 of the second rotary latch 5b, and rests against the front latching lug flank 24a of the third latching lug 24. For this, the rotary latch assembly has a pawl spring 44, to which the pawl 6 is connected such that it can be rotatably driven about the pawl rotational axis 39 counter to the pawl releasing direction 41. As a result, the pawl spring 44 drives the pawl 6 such that the pawl latching lugs 43a;b are pressed against the rotary latches 5a;b. The pawl spring 44 is supported at one end against the pawl 6 and at the other end against the lock case 4, in particular against a stop pin 63 fixedly connected to the base plate 7.

The pawl 6 also has a tappet 33. The tappet 33 is disposed in the region of the latching piece 42, and projects away therefrom. In particular, the tappet 33 protrudes from the pawl surface 36 facing the base plate 7. The tappet 33 thus extends parallel to the pawl rotational axis 39. Preferably, the tappet 33 is disposed adjacent to the second pawl latching lug 43b. Preferably, the pawl spring 44 bears against the tappet 33.

The closing device 3 of the door lock 1 according to the invention serves to automatically close the respective vehicle door or hatch when the rotary latches 5a;b are located in the preliminary latching position, or the safety latching position (FIGS. 2-6), in which position the door or hatch is not fully closed. For this, the closing device 3 has mechanical drive or coupling means for driving the rotary latches 5a;5b in the respective closing direction 18a;b of the rotary latches, a drive device 46 for driving the drive or coupling means, as well as a control device 47 for controlling the drive device 46.

The mechanical drive means comprise a drive lever 48 and a output lever or closing lever 49.

The drive lever 48 is preferably likewise designed in the shape of a plate, and has two, preferably substantially planar, drive lever surfaces 50 lying opposite one another, as well as an circumferential drive lever peripheral wall 51. Furthermore, the drive lever 48 has a drive arm 52 and a bearing arm 53. The drive arm 52 and the bearing arm 53 are connected to one another in a connecting region 54. Furthermore, the drive arm 52 and the bearing arm 53 are somewhat bent down in relation to one another.

The bearing arm 53 has a free bearing arm end 55 facing away from the drive arm 52. The bearing arm end 55 serves as the rotational bearing for the drive lever 48 about a drive lever rotational axis 56. The drive lever 48 is connected to the lock case 4, in particular the base plate 7, such that it can rotate about the drive lever rotational axis 56, and otherwise cannot be rotated or displaced. The drive lever rotational axis 56 is preferably coaxial to the rotary latch rotational axis 15b of the second rotary latch 5b thereby. As a result, the drive lever 48 is preferably supported on the same rotary latch bearing pin 14b as the second rotary latch 5b. The bearing recess in the drive lever 48 necessary for this is disposed on the bearing arm end 55.

The drive lever 48, in particular the drive lever peripheral wall 51, also has a stop depression 57. The cavity-like stop depression 57 is disposed in the region of the bearing arm 53, and is adjacent to the connection region 54.

The drive arm 52 has a free drive arm end 58, facing away from the bearing arm 53. The drive arm peripheral wall 51 has a drive surface 59 on the free end 58 of the drive arm. The drive surface 59 faces toward the second longitudinal wall 9b. Preferably, the drive arm 52 also has a plastic cap 60 on the drive arm end 48. The drive surface 59 is disposed in the region of the plastic cap 60, or a part of the plastic cap 60 forms the drive surface 59.

As explained above, the drive lever 48 is rotatably connected to the base plate 7 such that it can rotate about the drive lever rotational axis 56. Furthermore, there is a drive lever spring 61, which drives the drive lever 48 counter to a drive lever actuation direction 62 about the drive lever rotational axis 56. The drive lever spring 61 is supported at one end on the drive lever 48, in particular on the bearing arm 53, and is supported at the other end on the lock case 4, in particular the first longitudinal wall 9a. The rotational movement of the drive lever 48 is delimited by a stop pin 63. The stop pin 63 is fixedly connected to the base plate 7, and protrudes from it. The stop pin 63 serves as a counter bearing for the rotational movement of the drive lever 48 counter to the drive lever actuation direction 62. In its non-actuated initial position, the drive lever 48 bears against the stop pin 63 with the stop depression 57.

The closing lever 49 is likewise preferably designed in the shape of a plate, and has two closing lever surfaces 64 lying opposite one another that are preferably planar, as well as an circumferential closing lever peripheral wall 65. The closing lever surfaces 64 are preferably parallel to the base plate 7, or parallel to the rotary latch surfaces 19, or the pawl surfaces 36. Furthermore, the closing lever 49 has a closing lever bearing end 66 and a closing lever actuation end 67. The closing lever is rotatably connected at its closing lever bearing end 66 to the drive lever 48 such that it can rotate about a closing lever rotational axis 68, and otherwise, cannot be rotated or displaced. Furthermore, the two levers 48; 49 each have a continuous bearing recess, in which a bearing pin 69 is disposed. The closing lever rotational axis 68 is perpendicular to the closing lever surfaces 64, or parallel to the rotary latch rotational axes 15a;b and to the pawl rotational axis 39 as well as to the drive lever rotational axis 56. Moreover, the closing lever 49 is preferably connected to the drive lever 48 in the connecting region 54 of the drive lever 48.

The closing lever 49 also has a closing lever drive lug 70 on its closing lever actuation end 67. The closing lever drive lug 70 serves to drive the second rotary latches 5b, in particular to rotate the second rotary latches 5b in their rotary latch closing direction 18b. The closing lever drive lug 70 also engages in the third latching recess 27 of the second rotary latch 5b. A closing lever spring 71 is present for pushing the closing lever drive lug 70 into the third latching recess 27 of the second rotary latch 5b. The closing lever spring 71 is supported at one end on the drive lever 48 and at the other end on the closing lever 49, in particular at the closing lever actuation end 67. The closing lever spring 71 strives to push the closing lever 49 against the second rotary latch 5b with the closing lever actuation end 67. The closing lever spring 71 thus drives the closing lever about the closing lever rotational axis 68 in relation to the drive lever 48, such that the closing lever 49 is pushed against the second rotary latch 5b with the closing lever actuation end 67.

Furthermore, the closing lever 49 has a closing lever actuation lug 72 on its closing lever actuation end 67. The closing lever actuation lug 72 serves to actuate the closing lever 49 by means of the pawl 6. The closing lever actuation lug 72 is disposed adjacent to the closing lever drive lug 70. A closing lever recess is formed between the closing lever drive lug 72 and the closing lever actuation lug 70. The closing lever actuation lug 72 likewise faces toward the second rotary latch 5b. Furthermore, the closing lever actuation lug 72 has a lug wall 73 facing toward the closing lever drive lug 70. Moreover, the closing lever actuation lug 72 projects beyond the pawl surface 36 and the closing lever surface 64 facing away from the base plate 7. The closing lever actuation lug 72 is thus offset in relation to the closing lever drive lug 70. In particular, the closing lever actuation lug 72 is designed as a plastic cap 74.

The drive device 46 has a drive motor (not shown) as well as a drive disk 76 having a drive cam 77. The drive motor is preferably an electric motor. The drive disk 76 has a drive disk peripheral wall 78 as well as two opposing drive disk surfaces 79a;b. The drive disk 76 is connected to the drive motor such that it can be rotatably driven about a drive disk rotational axis 80 in a drive disk actuation direction 81. Furthermore, the drive disk 76 is disposed adjacent to the drive arm end 58. The drive disk rotational axis 80 represents the disk axis, and is parallel to the rotary latch rotational axes 15a;b. Furthermore, the drive disk 76 has a control pin 82 projecting radially from the drive disk peripheral wall 79.

The drive cam 77 has a cam peripheral wall 83. Furthermore, the drive cam 77 is formed on the first drive disk surface 79a facing toward the drive lever 48, and protrudes from it. In an non-actuated or non-driven standby position of the drive lever 48 and the closing lever 49 connected thereto, the drive surface 59 of the drive lever 48 does not bear against the cam peripheral wall 83. The cam peripheral wall 82 has an eccentric design in relation to the drive disk rotational axis 80.

The control device 47 has a control disk 84, as well as three sensors 85;86;87 and a control unit, in particular an electronic control unit, which is not shown.

The control disk 84 has two opposing control disk surfaces 88 as well as a control disk peripheral wall 89. The control disk peripheral wall 89 has a first cylindrical section 90, seen from the circumferential direction, as well as a first elevation 91 and a second elevation 92 adjacent thereto. The first and second elevations 91;92 protrude radially in comparison with the cylindrical section 90. A second cylindrical section 95 exists between the first and second elevations 91;92, the outer diameter of which corresponds to the outer diameter of the first cylindrical section 90.

Furthermore, the control disk 84 has a control disk tooth 93 projecting radially away from the control disk peripheral wall 89. A drive pin 93a protrudes away from the control disk tooth 93, which is disposed in the drive recess 29 of the first rotary latch 5a. The control disk 84 and the first rotary latch 5a are interlocked with one another as a result. The control disk 84 is thus connected to the first rotary latch 5a such that it can be driven rotatably back and forth about the control disk rotational axis 94 thereby. The control disk rotational axis 94 is preferably coaxial to the pawl rotational axis 39 thereby. Preferably, the control disk 84 is likewise supported on the pawl bearing pin 38. The control disk is thus connected to the lock case 4, in particular the base plate 7, such that it can rotate about the control disk rotational axis 94, and otherwise cannot be rotated or displaced.

The sensors 85;86;87 are preferably tactile sensors, which interact with the control disk 84, or the drive disk 76, respectively. The first and second sensors 85;86 sample the control disk peripheral wall 89. The third sensor 87 samples the drive disk peripheral wall 78. The sensors 85;86;87 are connected to the control unit such that they can transmit signals thereto.

The functionality of the vehicle door or hatch lock 1 shall now be explained below:

In an open position of the door lock 1 (FIG. 1), the striker pin 12 is located outside the lock case 4, between the recesses 17 of the two rotary latches 5a;5b. The locking lugs 16 pass through the slot in the first longitudinal wall 9a, and are pushed by the force of the rotary latch spring 31 against slot edges serving as stops, which are perpendicular to the base plate 7. In particular, the first rotary latch 5b is pushed into the open position by the rotary latch spring 31. The second rotary latch 5b is pushed or driven by the first rotary latch 5a into the open position, because the actuation lugs 21 of the two rotary latches 5a;5b are interlocked with one another. In particular, the actuation lug 21 of the first rotary latch 5a bears against the actuation lug rear wall 21b of the actuation lug 21 of the second rotary latch 5b with its actuation lug front wall 21a.

Furthermore, the pawl 6 bears against the second rotary latch latching lug 23 of the first rotary latch 5a with its first pawl latching lug 43a. In particular, the first pawl latching lug 43a bears against the rear latching lug flank 23b of the second latching lug 23 of the first rotary latch 5a. The second pawl latching lug 43b is disposed in the third latching recess 27 of the second rotary latch 5b, and bears against the front latching lug flank 24a of the third latching lug 24. The pawl 6 is not actuated in this position.

The drive pin 93a is disposed in the drive recess 29, as explained above. The control disk 84 is located in its initial position when the door lock 1 is open. In this initial position, the first sensor 85 bears against the first cylindrical section 90 of the control disk peripheral wall 89, and the second sensor 86 bears against the second cylindrical section 95 of the control disk peripheral wall 89.

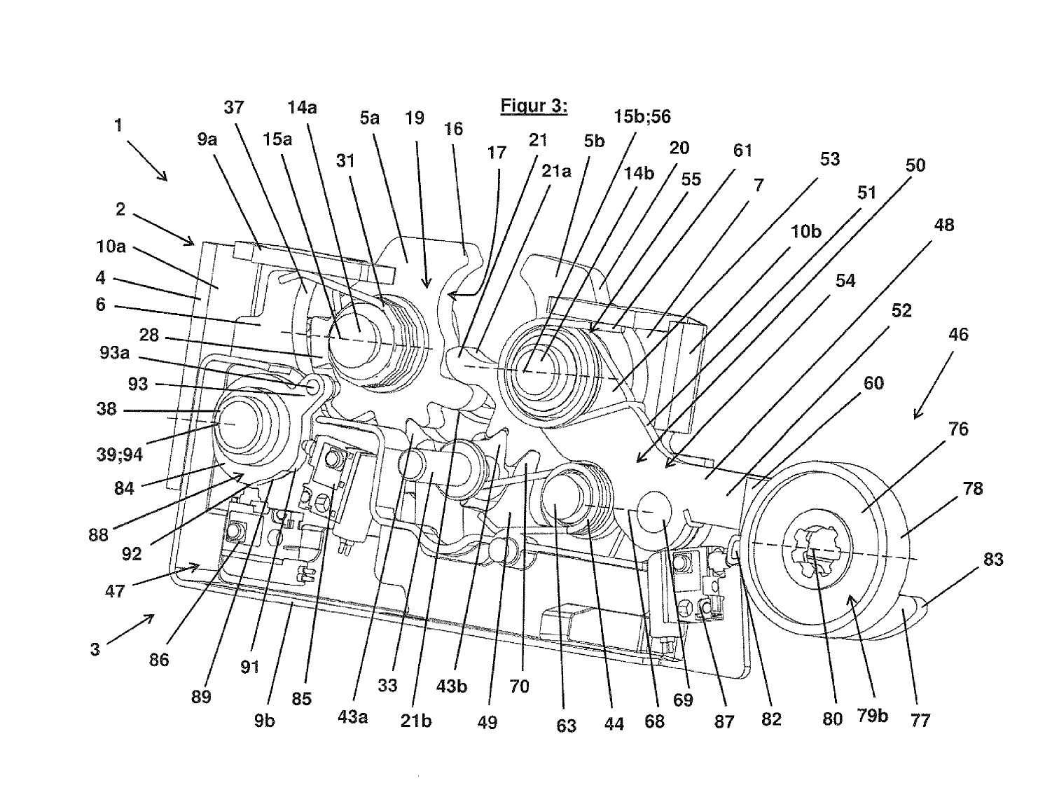

The drive lever 48 and the closing lever 49 are also in their un-actuated initial position, or standby position. In this position, the drive lever 48 bears against the stop pin 63 with the stop depression 57, driven by the drive lever spring 61. The drive disk 76 is rotated such that the drive cam 77 does not bear against the drive surface 59 of the drive lever 48. As a result, the drive lever 48 is not actuated. In this initial position of the drive disk 76, the third sensor 87 bears against the control pin 82 of the drive disk 76 (see FIGS. 2 and 3). The drive motor is likewise not actuated.

The closing lever 49, driven by the closing lever spring 71, bears against the third rotary latch latching lug 24 of the second rotary latch 5b with the closing latch drive lug 70. The closing lever drive lug 70 is disposed outside the third latching recess 27 of the second rotary latch 5b thereby. The tappet 33 of the pawl 6 is disposed between the closing lever drive lug 70 and the closing lever actuation lug 72.

If the door or hatch is closed, the striker pin 12 first pushes counter to a door closing direction (arrow 96) against the actuation lug front wall 21a of the actuation lug 21 of the second rotary latch 5b, and then against the recess 17 of the second rotary latch 5b, such that the second rotary latch 5b is pivoted in the rotary latch closing direction 18b. The second rotary latch 5b, in turn, drives the first rotary latch 5a, counter to the force of the rotary latch spring 31, in its rotary latch closing direction 18a via the two actuation lugs 21. The two rotary latches 5a;5b are pivoted in the opposing rotary latch closing directions 18a;b, such that the locking lugs 16 of the two rotary latches 5a;b are moved toward each other, and the striker pin 12 is partially encompassed. The locking lugs 16 are then located with the striker pin 12 partially inside the striker pin recess 11 in the lock case 4 (FIGS. 2-6). The locking lugs 16 are rotated thereby toward one another to the extent that the striker pin 12 can no longer escape from the region between the recesses 17, and the lock 1 can only move to a certain extent in relation to the striker pin 12. This position is referred to as the preliminary latching position or safety latching position of the rotary latches. The door or hatch can no longer be opened, but is not yet fully closed.

As a result of the rotational movement of the two rotary latches 5a;b, each of the two second latching recesses 26 of the two rotary latches 5a;b also end up in the region of the pawl latching lugs 43a;b that are subjected to spring pressure. The first pawl latching lug 43a then snaps into the second latching recess 26 of the first rotary latch 5a through the pressure of the pawl spring 44, and the second pawl latching lug 43b snaps into the second latching recess 26 of the second rotary latch 5b. The two rotary latches 5a;b are blocked or locked in place as a result. This means that the two rotary latches 5a;b can no longer rotate in the rotary latch opening directions 32a;b through the force of the rotary latch spring 31.

As a result of the rotational movement of the second rotary latch 5b, the closing lever drive lug 70 also ends up in the third latching recess 27 of the second rotary latch 5b, and snaps in place therein due to the force of the closing lever spring 71. The drive lever 48 remains in its standby position. The drive disk 76 also remains in its standby position.

The rotation of the first rotary latch 5a in the rotary latch closing direction 18a causes the control disk 84 to rotate about the control disk rotational axis 94 in a control disk closing direction 97. The control disk 84 is driven by the first rotary latch 5a in the manner of a gearwheel, because the drive pin 93a is disposed in the drive recess 29. The control disk 84 is rotated until the first sensor 85 is still disposed in the first cylindrical section 90 of the control disk peripheral wall 89, but the second sensor 86 then bears against the second elevation 92. As a result, the signal of the second sensor 86 to the control unit changes. This triggers the start-up of the drive motor, such that it rotates the drive disk 76 about the drive disk rotational axis 80 in the drive disk actuation direction 62. As soon as the drive cam 77 engages with the drive surface 59 of the drive lever 48, it is driven in the drive lever actuation direction 62. This also causes, in particular, a rotation of the connecting region 54 of the drive lever 48. As a result, the closing lever bearing end 66 is likewise carried along therewith. The closing lever 49 is thus retracted. Because the closing lever drive lug 70 is disposed in the third latching recess 27 of the second rotary latch 5b, the closing lever 49, while retracting, rotates the second rotary latch 5b further in its rotary latch closing direction 18b. The second rotary latch 5b, in turn, drives the first rotary latch 5a in its rotary latch closing direction 18a. The two rotary latches 5a;b are rotated until the striker pin 12 is disposed in a form-fitting manner in the recesses 17, and is thus securely encompassed (FIGS. 7 and 8). The rotary latches 5a;b are then located in their final latching position. And the vehicle lock 1 is then in its completely closed position.

As a result of the rotational movement of the two rotary latches 5a;b, the first latching recesses 25 of the two rotary latches 5a;b end up in the region of the pawl latching lugs 43a;b subjected to spring pressure. The first pawl latching lug 43a then snaps into the first latching recess 25 of the first rotary latch 5a through the pressure of the pawl spring 44, and the second pawl latching lug 43b snaps into the first latching recess 25 of the second rotary latch 5b. The two rotary latches 5a;b are again blocked or locked in position as a result.

The rotation of the first rotary latch 5a in the rotary latch closing direction 18a causes, in turn, the control disk 84 to rotate about the control disk rotational axis 94 in the control disk closing direction 97. The control disk 84 is rotated until the first sensor 85 is disposed at the first elevation 91 of the control disk peripheral wall 89, and the second sensor 86 still bears against the second elevation 92. As a result, the signal from the first sensor 85 to the control unit changes. This is the indication that the door lock 1 has reached its fully closed position.

The drive motor is controlled thereby such that the drive disk 76 rotates once through 360° , until it is again in its standby position (FIG. 8). The standby position is recognized in that the third sensor 87 again bears against the control pin 82, and transmits a corresponding signal to the control unit. This then stops the drive motor. As a result, the drive cam 77 becomes disengaged from the drive lever 48. The drive lever 48 returns to its standby position, driven by the force of the drive lever spring 61. The closing lever 49, in particular the closing lever drive lug 70 is moved out of the third latching recess 27 of the second rotary latch 5b to a large extend as a result. The closing lever drive lug 70 then bears against the second rotary latch latching lug 23, in particular in the transition of the front latching lug flank 23a to the rear latching lug flank 23b of the second rotary latch 5b.

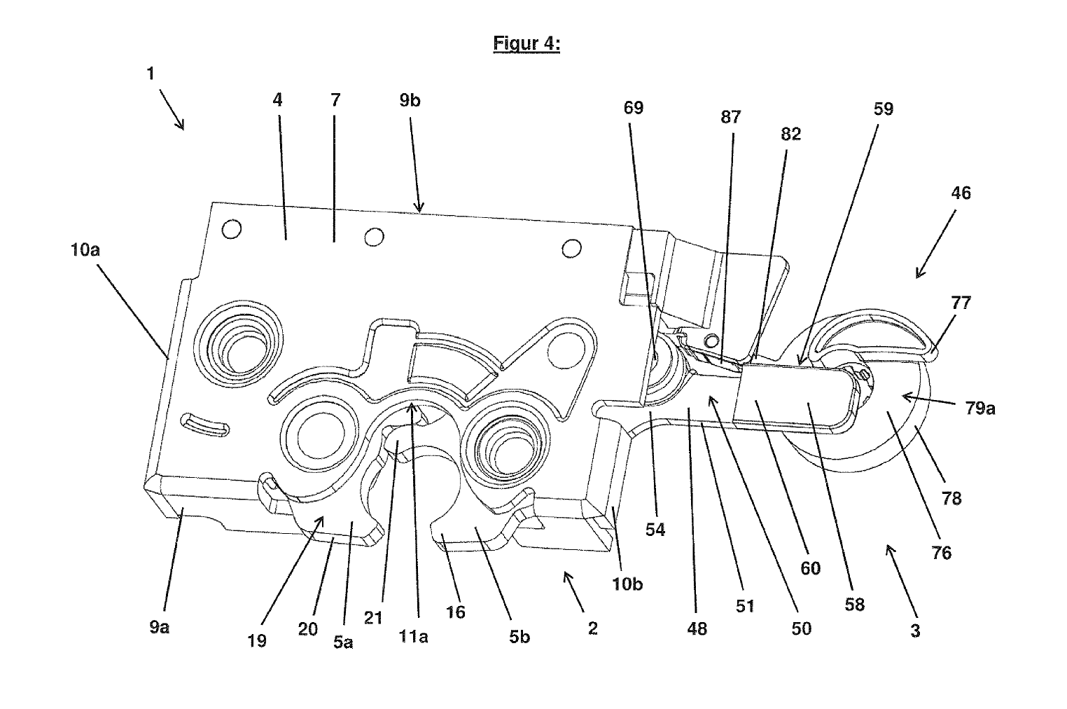

To open the door lock 1 according to the invention from the preliminarily latched safety latching position (FIG. 2), or from the closed position (FIGS. 3, 4), thus to release the two rotary latches 5a;b, the pawl 6 is pivoted in the pawl releasing direction 41 counter to the force of the pawl spring 44. By way of example, the actuation lever that engages in the lock case 4 is used for this. This can be actuated, in turn, by a pull handle mechanism, a push button mechanism, or suchlike, from the interior or exterior of the vehicle. By rotating the pawl 6 in the pawl releasing direction 41, the latching piece 42 is moved away from the rotary latches 5a;b, such that the latching lugs 43a;b are moved out of the respective latching recesses 25;26. As a result, the two rotary latches 5a;b are released and snap back into their opened initial position (FIG. 1) under the pressure of the rotary latch springs 31, until the locking lugs 16 again strike against the slot edges of the slot in the first longitudinal wall 9a. The two rotary latches 5a;b thus rotate in the rotary latch opening direction 32a;b. The first rotary latch 5a drives the second rotary latch 5b thereby. The striker pin 12 is pushed out of the lock case 4 thereby. The door lock 1 is again in its open position. After releasing the pawl 6, it snaps back into its non-actuated initial position, driven by the force of the pawl spring 44.

Due to the rotation of the first rotary latch 5a, the control disk 84 also rotates back to its initial position.

In order to prevent the closing lever 49 from interfering with the rotational movement of the two rotary latches 5b, it is also disengaged from the second rotary latch 5b. In particular, the closing lever 49 is pivoted about the closing lever rotational axis 68 by means of the pawl 6, such that the closing lever drive lug 70 is moved away from the second rotary latch 5b. Thereto, the tappet 33 of the pawl 6 pushes onto the closing lever actuation lug 72 when the pawl 6 is actuated. After releasing the pawl 6, the closing lever 49 snaps back into its non-actuated initial position, or standby position, driven by the force of the closing lever spring 71.

The vehicle lock according to the invention comprises, on one hand, a high operational reliability. Despite the closing device, the lock can always be manually released, because the release of the rotary latches by means of the pawl always also decouples or disengages the closing device from the rotary latches. Furthermore, the force transmission and coupling occurs purely mechanically by means of the drive lever and the closing lever. The drive for the rotary latches via the lever, and not via the striker pin, is particularly simple and reliable.

A further advantage is that the door lock according to the invention can continue to be used as a “normal” lock, even when the electronics of the closing device or the components thereof, or the drive motor, should malfunction. The closing function of the lock is thus always ensured, independently of the operational reliability or function or functional capability of the closing device. The rotary latches are driven by the striker pin from their open position into their final latching position in the rotary latch closing direction when closing the vehicle door, independently of whether or not the closing device functions. The functioning of the rotary latch assembly is thus independent of the functioning of the closing device. The purely mechanical rotary latch assembly always functions.

Of course, other sensors may be used within the scope of the invention, e.g. optical sensors. Because the most frequent position of the lock is the closed position, the sensors are preferably configured such that no current flows when in the closed position.

Furthermore, it is within the scope of the invention to vary the control. By way of example, the control can be configured such that, after detecting the preliminary latching position, the closing device is not moved immediately, but rather, this occurs due to a radio signal transmitted by the key. The operator can thus initiate the closing procedure by means of the key. This prevents a pinching of fingers or other body parts in the door. It is also possible that the closing procedure is first triggered through starting the vehicle motor or by the ignition. The initiation of the closing procedure can also be made to be dependent on whether or not the striker pin is located between the two rotary latches. This likewise prevents a pinching of fingers when, for example, the rotary latches are unintentionally brought into their preliminary latching position through pushing randomly against the lock. If these do then immediately rotate further, there is a risk of pinching.

The sensor that indicates the position of the drive disk can also be eliminated, thus simplifying the control and construction of the door lock. As a result, the control pin at the drive disk can also be omitted. The control of the rotational movement of the drive disk is then somewhat different: As soon as the preliminary latching position has been reached, and detected by the two other sensors, the motor is started. When the rotary latches reach their final latching position, or main latching position, respectively, this is detected in turn by the two sensors. At this point, the motor continues to rotate for a predetermined time x, until the drive disk is again located in its initial position.

It is also within the scope of the invention that the pawl is actuated on the tappet. Thereto, it extends beyond the cover wall of the lock case.

1. A vehicle lock for locking doors or hatches of motor vehicles, in particular doors or hatches of agricultural machines, such as tractors or construction machines, having
a rotary latch assembly having two rotatably supported rotary latches for encompassing and retaining a striker pin in one of a preliminary latching position and a final latching position thereof, and having a pawl for locking the two rotary latches in the preliminary latching position and the final latching position, and
a closing device, with which the rotary latches are connected such that they can be rotatably driven in a respective rotary latch closing direction from the preliminary latching position into the final latching position.

2. The vehicle lock according to claim 1, wherein the rotary latch closing directions of the two rotary latches are counter to one another.

3. The vehicle lock according to claim 1, wherein the rotary latch assembly has a lock case, in which the two rotary latches and a pawl are rotatably supported.

4. The vehicle lock according to claim 3, wherein the two rotary latches are each rotatably connected to the lock case such that they can rotate about a rotary latch rotational axis.

5. The vehicle lock according to claim 3, wherein the pawl is rotatably connected to the lock case such that it can rotate about a pawl rotational axis, wherein the pawl rotational axis is parallel to the rotary latch rotational axes.

6. The vehicle lock according to claim 1, wherein the two rotary latches interlock in the manner of gearwheels.

7. The vehicle lock according to claim 6, wherein the two rotary latches each have an actuation lug, wherein the two rotary latches are interlocked with one another via the actuation lugs.

8. The vehicle lock according to claim 1, wherein the first rotary latch of the two rotary latches is connected to a rotary latch spring such that it can be driven rotationally in a rotary latch opening direction counter to its rotary latch closing direction.

9. The vehicle lock according to claim 8, wherein the second rotary latch of the two rotary latches is connected to the rotary latch spring via the first rotary latch such that it can be driven rotationally in a rotary latch opening direction counter to its rotary latch closing direction.

10. The vehicle lock according to claim 1, wherein the two rotary latches have latching members and the pawl has counter latching members corresponding thereto, which interact with the latching members of the rotary latches locking these in the preliminary latching position or final latching position.

11. The vehicle lock according to claim 10, wherein the pawl has a first and second pawl arm, wherein the first and second pawl arms are fixedly connected to one another at one end, wherein the second pawl arm has a latching piece on its free end facing away from the first pawl arm, which has two pawl latching lugs facing toward the rotary latches.

12. The vehicle lock according to claim 11, wherein the pawl has a tappet, that is disposed in the region of the latching piece and protrudes therefrom.

13. The vehicle lock according to claim 1, wherein the closing device has a drive device with a drive motor, in particular an electric motor, to which the rotary latches are mechanically connected, such that they can be driven rotationally in the respective rotary latch closing direction from the preliminary latching position into the final latching position.

14. The vehicle lock according to claim 1, wherein the closing device has the mechanical connection for driving the rotary latches in the respective rotary latch closing direction, the drive device for driving the drive means, as well as a control device for controlling the drive device.

15. The vehicle lock according to claim 14, wherein the mechanical connection has a drive lever and a closing lever.

16. The vehicle lock according to claim 15, wherein the drive lever has a drive arm and a bearing arm, wherein the drive arm and the bearing arm are fixedly connected to one another in a connecting region, and wherein the drive arm and the bearing arm are preferably bent away from one another.

17. The vehicle lock according to claim 16, wherein the bearing arm has a free bearing arm end facing away from the drive arm, wherein the drive lever is rotatably connected to the lock case within the region of the bearing arm end such that it can rotate about a drive lever rotational axis, wherein the drive lever rotational axis is preferably coaxial to the rotary latch rotational axis of the second rotary latch.

18. The vehicle lock according to claim 15, wherein the closing lever has a closing lever bearing end and a closing lever actuation end, and is connected to the drive lever at its closing lever bearing end such that it can rotate about a closing lever rotational axis, and otherwise cannot be rotated or displaced.

19. The vehicle lock according to claim 17, wherein the drive lever is connected to the drive motor such that it can be driven rotationally in a drive lever actuation direction, about a drive lever rotational axis, from a non-actuated position into an actuated position.

20. The vehicle lock according to claim 19, wherein the closing lever is connected to the drive motor via the drive lever, such that it can be driven from a non-actuated position into an actuated position, wherein the closing lever is connected to the second rotary latch such that a movement of the closing lever from its non-actuated position into its actuated position causes a rotation of the rotary latch from its preliminary latching position into its final latching position.

21. The vehicle lock according to claim 18, wherein the closing lever has a closing lever drive lug on its closing lever actuation end, which serves to drive the second rotary latch in its rotary latch closing direction.

22. The vehicle lock according to claim 21, wherein, in a position of the closing lever driving the rotary latch, the closing lever drive lug engages in a form-fitting manner in a latching recess of the second rotary latch.

23. The vehicle lock according to claim 1, wherein the closing device is connected to the pawl such that it can be actuated such that the closing device can be brought out of engagement with the rotary latches through actuating the pawl, in particular through rotating the pawl in a pawl releasing direction.

24. The vehicle lock according to claim 23, wherein the closing lever is connected to the pawl such that it can be actuated such that the closing lever can be brought out of engagement with the second rotary latch through actuating the pawl, in particular through rotating the pawl in a pawl releasing direction.

25. The vehicle lock according to claim 24, wherein the closing lever is connected to the pawl such that it can be actuated such that the closing lever drive lug can be moved out of the latching recess of the second rotary latch through actuating the pawl, in particular through rotating the pawl in a pawl releasing direction.

26. The vehicle lock according to claim 1, wherein the two rotary latches, in particular through pressure on the actuation lug of the second rotary latch, can be driven from their open position into their final latching position in the rotary latch closing direction, independently of the operational reliability, or functionality of the closing device.

27. A vehicle having a vehicle body and a vehicle door or hatch, and a vehicle lock as well as a striker pin for locking the vehicle door or hatch, wherein the vehicle has a vehicle lock according to claim 1.

28. The vehicle according to claim 27, wherein the rotary latch assembly is disposed in the vehicle door or hatch, and the striker pin is fixedly connected to the vehicle body.
